(19) United States
(12) Patent Application Publication
(10) Pub. No.: US 2006/0257715 A1
(43) Pub. Date: Nov. 16, 2006

(54) Direct oxidation fuel cell and manufacturing method therefor

(75) Inventor: Hideyuki Ueda, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/430,981

(22) Filed: May 10, 2006

(30) Foreign Application Priority Data
May 16, 2005 (JP) 2005-142642

(51) Int. Cl. H01M 4/86; H01M 4/88; B05D 5/12

(52) U.S. Cl. 429/41; 429/42; 502/101; 427/115

(57) ABSTRACT

A fuel cell of the present invention has a membrane-electrode assembly including a cathode, an anode, and a solid polymer electrolyte membrane disposed between the cathode and the anode. The cathode includes a cathode catalyst layer and a cathode diffusion layer. The cathode catalyst layer is facing the solid polymer electrolyte membrane. The anode includes an anode catalyst layer and an anode diffusion layer. The anode catalyst layer is facing the solid polymer electrolyte membrane. Between the cathode catalyst layer and the solid polymer electrolyte membrane, a cathode protective layer is formed, and between the anode catalyst layer and the solid polymer electrolyte membrane, an anode protective layer is formed. Both of the cathode protective layer and the anode protective layer include a polymer electrolyte and water-repellent particles. The cathode and anode protective layers are formed to cover cracks in the cathode catalyst layer and the anode catalyst layer.

### FIELD OF THE INVENTION

The present invention relates to direct oxidation fuel cells in which fuels are used without being reformed into hydrogen.

### BACKGROUND OF THE INVENTION

As mobile electronic devices such as mobile phones, personal data assistants (PDA), laptop computers, and camcorders becoming multi-functional, power consumption and continuous use time are increasing. For the increasing power consumption and continuous use time, batteries to be mounted on mobile electronic devices are desired to have a higher energy density.

Currently, lithium secondary batteries are mainly used as a power source for mobile electronic devices. The energy density of lithium secondary batteries are expected to hit its limit at about 600 Wh/L in the near future. Thus, fuel cells using a solid polymer electrolyte membrane are expected to replace the lithium ion secondary batteries as the power source, and early practical utilization of fuel cells is desired.

Among the fuel cells, researches and developments are actively conducted for direct oxidation fuel cells, in which methanol or dimethyl ether as a fuel is supplied to the inside of the cell without reformation to hydrogen for generating electricity. This is because direct oxidation fuel cells are gaining attention since organic fuels have a higher theoretical energy density, the system can be simplified easily, and the fuel can be stored easily.

Direct oxidation fuel cells are formed of a plurality of unit cells. The unit cell comprises an electrolyte membrane-electrode assembly (MEA) and separators disposed on both sides of the MEA. The electrolyte membrane-electrode assembly (MEA) includes a solid polymer electrolyte membrane, an anode attached to one side of the MEA, and a cathode attached to the other side of the MEA. Both of the anode and cathode include a catalyst layer and a diffusion layer. In direct oxidation fuel cells, a fuel and water are supplied to the anode, and an oxidant such as air is supplied to the cathode to generate electricity.

An electrode reaction of direct methanol fuel cells (DMFC) in which methanol is used as a fuel is shown below, for example.
Anode: CH₃OH+H₂O→CO₂+6H⁺+6e⁻
Cathode: 3/2O₂+6H⁺+6e⁻→3H₂O

That is, in the anode, methanol and water are reacted to produce carbon dioxide, protons, and electrons. The protons reach the cathode via the electrolyte membrane. In the cathode, electrons reached the cathode via an external circuit, oxygen, and protons are reacted to produce water.

However, there are some problems in practical utilization of such direct oxidation fuel cells.

For the electrolyte membrane of direct oxidation fuel cells, a perfluoroalkylsulfonic acid membrane, for example, is used, in view of proton conductivity, heat-resistance, and oxidation-resistance. Such type of electrolyte membrane comprises a main chain of a hydrophobic polytetrafluoroethylene (PTFE), and a side chain in which a hydrophilic sulfonic acid group is fixed at an end of a perfluoroalkyl group. Therefore, when a substance having both hydrophilic portion and hydrophobic portion in its molecules, such as methanol, is used as a fuel, the fuel is a good solvent for the perfluoroalkylsulfonic acid membrane, and easily passes the electrolyte membrane. In other words, the fuel supplied to the anode passes the electrolyte membrane without being reacted and reaches the cathode, i.e., a so-called “cross over” phenomenon occurs.

Additionally, in many cases, in the process of applying and drying the catalyst paste, cracks are generated and remain in the catalyst layers of the anode and the cathode. Since the fuel applied to the anode migrates to the cathode via such cracks, the cross over amount increases. As a result, the fuel utilization efficiency decreases and the potential of the cathode declines, causing drastic deterioration in electricity generation performance. Especially, since the cross over amount via the cracks tends to increase when the fuel concentration is high, in the current situation, the fuel concentration has to be set to low. Thus, a container capable of containing a large amount of fuel needs to be provided, and this is being a major obstacle in downsizing fuel cell systems.

Further, a problem in interface bonding between the solid polymer electrolyte membrane and the catalyst layers also exists. The MEA is typically manufactured by hot pressing. In this method, the electrolyte membrane is sandwiched between the anode and the cathode, and a pressure of about 100 kg/cm² is applied under a high temperature of 130 to 150° C. to weld and integrate the anode, the electrolyte membrane, and the cathode. However, in this method, the pressure upon hot pressing needs to be set higher as in the above, to ensure the interface bonding between the electrolyte membrane and the catalyst layers. Thus, there are problems in that a porosity of the catalyst layers and the diffusion layers decreases, and diffusivity of fuel and air and discharge of generated carbon dioxide decline in the MEA, leading to a decline in electricity generation performance. Further, because of a reduction in mechanical strength of the diffusion layers themselves, diffusion layers are damaged and partially cracked, reducing their durability.

To counter the problems as noted above, there have been proposed to provide unevenness at the interface between the electrolyte membrane and at least one of the anode and the cathode, for example, (Japanese Laid-Open Patent Publication No. 2003-123786).

However, such structure makes it difficult to provide a direct oxidation fuel cell fuel with excellent electricity generation performance without decreasing fuel utilization efficiency, and many problems still remain. The technique disclosed in Japanese Laid-Open Patent Publication No. 2003-123786 may ensure the interface bonding between the electrolyte membrane and the catalyst layers, and suppression of damage to the diffusion layer, i.e., a decrease in porosity, cracks, or damage of the diffusion layer may be suppressed. However, the technique disclosed in Japanese Laid-Open Patent Publication No. 2003-123786 does not present a solution to the fuel cross over via the cracks of the catalyst layers.

Thus, the present invention aims to provide a direct oxidation fuel cell excellent in fuel utilization efficiency and electricity generation performance.

### BRIEF SUMMARY OF THE INVENTION

The present invention relates to a direct oxidation fuel cell comprising a membrane-electrode assembly including a cathode, an anode, and a solid polymer electrolyte membrane disposed between the cathode and the anode:

wherein the cathode includes a cathode catalyst layer facing the solid polymer electrolyte membrane, and a cathode diffusion layer;

the anode includes an anode catalyst layer facing the solid polymer electrolyte membrane, and an anode diffusion layer;

a cathode protective layer is formed between the cathode catalyst layer and the solid polymer electrolyte membrane;

an anode protective layer is formed between the anode catalyst layer and the solid polymer electrolyte membrane; and

both of the cathode protective layer and the anode protective layer include a polymer electrolyte and water-repellent particles. The cathode protective layer and the anode protective layer are formed to cover cracks existing on the anode and cathode catalyst layers.

The amount of the water-repellent particles in the protective layer is preferably larger at a solid polymer electrolyte membrane side than at a catalyst layer side. The protective layer further preferably includes a first protective layer contacting the catalyst layer and a second protective layer contacting the solid polymer electrolyte membrane,

the first protective layer not including the water-repellent particles but including the polymer electrolyte, and

the second protective layer including the water-repellent particles and the polymer electrolyte.

The water-repellent particles preferably include a fluorocarbon resin. The polymer electrolyte preferably comprises at least one ion-conductive functional group selected from the group consisting of a phosphonyl group, a phosphinyl group, a sulfonyl group, a sulfinyl group, a carboxyl group, a sulfo group, a mercapto group, an ether binding group, a hydroxyl group, a quaternary ammonium group, an amino group, and a phosphate group.

A fuel supplied to the anode preferably includes at least one organic compound selected from the group consisting of methanol and dimethyl ether.

Also, the present invention relates to a method of manufacturing a direct oxidation fuel cell, the method including the steps of:

(a) forming a cathode catalyst layer and an anode catalyst layer, both of the cathode catalyst layer and the anode catalyst layer having cracks;

(b) forming a cathode protective layer including a polymer electrolyte and water-repellent particles on the cathode catalyst layer, and an anode protective layer including a polymer electrolyte and water-repellent particles on the anode catalyst layer; and

(c) joining a solid polymer electrolyte membrane and the cathode catalyst layer with the cathode protective layer interposed therebetween, and the solid polymer electrolyte membrane and the anode catalyst layer with the anode protective layer interposed therebetween.

It is preferred that the step (b) further includes the steps of:

applying a first paste not including water-repellent particles but including a polymer electrolyte on each catalyst layer to form a first protective layer so that the cracks are covered; and

applying a second paste including a polymer electrolyte and water-repellent particles on the first protective layer to form a second protective layer.

In step (b), the step of forming the first protective layer preferably includes spraying the first paste on the catalyst layer and drying the applied first paste, and the step of forming the second protective layer preferably includes spraying the second paste on the first protective layer and drying the applied second paste. At this time, the surface temperature of the catalyst layer at the time of spraying the first paste or the surface temperature of the first protective layer at the time of spraying the second paste are preferably set to 40 to 80° C.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 schematically illustrates a vertical cross section of an MEA included in a fuel cell according to an embodiment of the present invention.

FIG. 2 schematically illustrates a vertical cross section of protective layers of an MEA included in a fuel cell according to another embodiment of the present invention.

FIG. 3 schematically illustrates a structure of a spraying apparatus for forming a protective layer on a catalyst layer.

### DETAILED DESCRIPTION OF THE INVENTION

Hereinafter, embodiments of the present invention are described with reference to the drawings.

### Embodiment 1

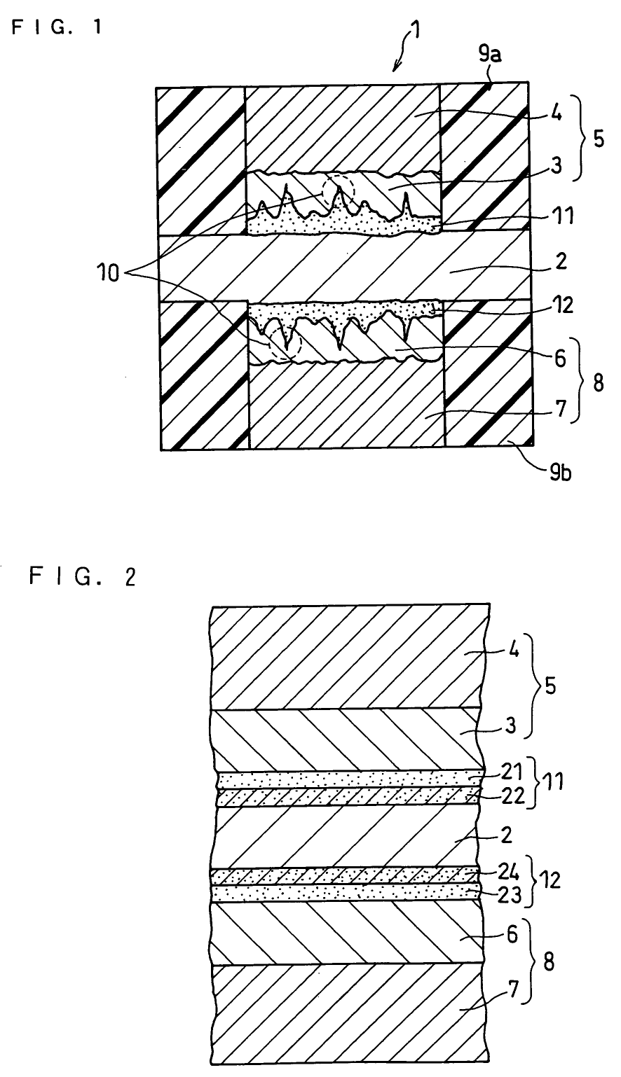

FIG. 1 shows a structure of an electrolyte membrane-electrode assembly (MEA) included in a fuel cell according to an embodiment of the present invention. An MEA 1 in FIG. 1 comprises a solid polymer electrolyte membrane 2, an anode 5, and a cathode 8. The anode 5 comprises an anode catalyst layer 3 and an anode diffusion layer 4. The cathode 8 comprises a cathode catalyst layer 6 and a cathode diffusion layer 7. In the fuel cell comprising the MEA 1 in FIG. 1, a fuel is supplied to the anode, and an oxidant such as air is supplied to the cathode to generate electricity.

The solid polymer electrolyte membrane 2 is sandwiched between the anode 5 and the cathode 8. The anode catalyst layer 3 in the anode 5 and the cathode catalyst layer 6 in the cathode 8 are facing the solid polymer electrolyte membrane 2.

Further, surrounding the anode 5 and the cathode 8 are gas sealing materials 9a and 9b for preventing fuel and air leakage.

Between the solid polymer electrolyte membrane 2 and the anode catalyst layer 3, an anode protective layer 11 is formed and between the solid polymer electrolyte membrane 2 and the cathode catalyst layer 6, a cathode protective layer 12 is formed. Both of the anode protective layer 11 and the cathode protective layer 12 include at least a polymer electrolyte and water-repellent particles. The anode catalyst layer 3 and the cathode catalyst layer 6 usually have cracks.

By providing such a protective layer on a surface of the anode catalyst layer 3 and of the cathode catalyst layer 6 facing the solid polymer electrolyte membrane, cracks 10 possibly existing in the anode catalyst layer 3 and in the cathode catalyst layer 6 can be covered. Covering the cracks on the catalyst layers with the protective layers increases the thickness of the regions containing the polymer electrolyte. Further, in the protective layer, the water-repellent particles form a micro-aggregate structure. These increase in thickness and aggregate structure enable a drastic decrease in penetration speed of the fuel that migrates in the protective layer. Thus, by providing the protective layer, the migration amount of unreacted fuel to the cathode catalyst layer via the catalyst layer cracks (the cross over amount) can be decreased drastically.

Additionally, even when the solid polymer electrolyte membrane, the anode, and the cathode are hot pressed with a low pressure, the provision of the protective layer ensures the interface bonding and decreases the interface resistance between the solid polymer electrolyte membrane and each catalyst layer.

Thus, a direct oxidation fuel cell with excellent electricity generation performance can be provided without deteriorating the fuel utilization efficiency.

Although the anode protective layer 11 and the cathode protective layer 12 in FIG. 1 are formed to cover and fill all the cracks, the protective layers formed to cover all the cracks will suffice without filling out all the cracks.

For the water-repellent particles, the particles comprising a general water-repellent material in the art may be used. Particularly, a fluorocarbon resin is preferably used for a material forming the water-repellent particles. By using fluorocarbon resins having a chemically stable C—F bond, a surface with a low degree of interaction with water molecules, i.e., a so-called water-repellent surface, can be formed.

Examples of the fluorocarbon resin include, a polytetrafluoroethylene resin (PTFE), a tetrafluoroethylene-hexafluoropropylene copolymer (FEP), a polyvinyl fluoride resin (PVF), a polyvinylidene fluoride resin (PVDF), and a tetrafluoroethylene-perfluoro(alkylvinylether) copolymer (PFA).

For the polymer electrolyte, a polymer excellent in heat-resistance and chemical stability is preferably used. Particularly preferable example is a polymer electrolyte having at least one ion-conductive functional group selected from the group consisting of a phosphonyl group, a phosphinyl group, a sulfonyl group, a sulfinyl group, a carboxyl group, a sulfo group, a mercapto group, an ether binding group (—O—), a hydroxyl group, a quaternary ammonium group, an amino group, and a phosphate group. Since the polymer electrolyte in the protective layer has a functional group that holds protons but easily release protons such as the ones shown in the above, migration of protons in the thickness direction of the protective layer improves. Thus, electricity generation performance of the fuel cell can be further improved.

The polymer electrolyte and the water-repellent particles contained in the anode protective layer and in the cathode protective layer may be the same or different.

The thickness of the protective layer is preferably as small as possible, to maintain proton conductivity. For example, the thickness of the protective layer is preferably about 10 μm or less.

The ratio of the water-repellent particles relative to the total of the polymer electrolyte and the water-repellent particles in the protective layer is preferably 10 wt % or more.

The amount of the water-repellent particles is preferably larger at a solid polymer electrolyte membrane side than at a catalyst layer side of the protective layer. The larger amount of the water-repellent particles in the solid polymer electrolyte membrane side drastically decreases the cross over amount of the fuel passing through the cracks in the catalyst layer of the anode and the cathode, without decreasing the area of three-phase interface in the catalyst layer, i.e., the active electrode surface.

For example, the protective layer may comprise a first protective layer not including the water-repellent particles and a second protective layer including the water-repellent particles to increase the amount of the water-repellent particles at the solid polymer electrolyte membrane side than at the catalyst layer side of the protective layer. The protective layer comprising the above-mentioned two layers is described by referring to FIG. 2. FIG. 2 illustrates an MEA comprising a protective layer including a first protective layer and a second protective layer. The same elements with the ones in FIG. 1 are shown with the same number in FIG. 2. The cracks in the catalyst layer are not shown.

As shown in FIG. 2, an anode protective layer 11 is formed of a first protective layer 21 including a polymer electrolyte but not including water-repellent particles, and a second protective layer 22 including a polymer electrolyte and water-repellent particles. Similarly, a cathode protective layer 12 is formed of a first protective layer 23 and a second protective layer 24. The first protective layer is disposed at a catalyst layer side of the protective layer.

By forming the protective layer in such a way, the first protective layer acts as a binder, enabling secure and sufficient connectivity between the solid polymer electrolyte membrane and the catalyst layer.

The amount of water-repellent particles may be increased gradually from the catalyst layer side toward the solid polymer electrolyte membrane side in the protective layer. Such a protective layer can be formed, for example, by using pastes with different amounts of the water-repellent particles.

The anode catalyst layer 3 and the cathode catalyst layer 6 are mainly composed of a polymer electrolyte, and metal catalyst particles or electroconductive particles carrying a metal catalyst. For the metal catalyst of the anode catalyst layer 3, for example, platinum (Pt)-ruthenium (Ru) alloy particles are used. For the metal catalyst of the cathode catalyst layer 6, for example, Pt particles are used. The thickness of the catalyst layer is preferably about 10 to 50 μm in the anode and in the cathode.

The anode diffusion layer 4 and the cathode diffusion layer 7 are formed of a material that diffuses the fuel and air, discharges carbon dioxide or water generated by electricity production, and conducts electrons. For such a material, for example, a conductive porous base material such as a carbon paper and a carbon cloth may be used. Also, based on conventional technique, the conductive porous material may be subjected to a water-repellent treatment. Further, on the surface of the conductive porous base material at a catalyst layer side, a water-repellent carbon layer may be provided.

For the solid polymer electrolyte membrane, a material having proton conductivity may be used without particular limitation.

The polymer electrolyte forming the solid polymer electrolyte membrane and the polymer electrolyte included in the catalyst layer may be the same polymer electrolyte with the one included in the protective layer.

The fuel supplied to the anode preferably includes at least one organic compound selected from the group consisting of methanol and dimethyl ether. By using at least one of such methanol and dimethyl ether having no carbon-to-carbon bond as a fuel, anode reaction polarization can be decreased. Also, ethylene glycol may be used as a fuel. When ethylene glycol is used as a fuel, to improve oxidation reaction of ethylene glycol, a mixture of ethylene glycol and an aqueous alkaline solution such as KOH is preferably used as a fuel.

An example of a manufacturing method of a protective layer is described below. The protective layer may be manufactured by a manufacturing method other than this method.

For example, the above protective layer comprising the first protective layer and the second protective layer may be formed by a method including the steps of:

(a) forming a cathode catalyst layer and an anode catalyst layer;

(b) forming a cathode protective layer including a polymer electrolyte and water-repellent particles on the cathode catalyst layer, and an anode protective layer including a polymer electrolyte and water-repellent particles on the anode catalyst layer; and

(c) joining a solid polymer electrolyte membrane and the cathode catalyst layer with the cathode protective layer interposed therebetween, and the solid polymer electrolyte membrane and the anode catalyst layer with the anode protective layer interposed therebetween.

The step (b) further includes the steps of:

applying a first paste not including water-repellent particles but including a polymer electrolyte on each catalyst layer to form a first protective layer; and

applying a second paste including a polymer electrolyte and water-repellent particles on the first protective layer to form a second protective layer. The protective layer is formed to cover the cracks of each catalyst layer.

This method enables to cover the cracks possibly exist in the catalyst layers with the protective layer including the polymer electrolyte and the water-repellent particles. Thus, the amount of the fuel cross over via the cracks of the catalyst layers can be decreased drastically.

Further, the protective layer manufactured by the above method includes a first protective layer contacting the catalyst layer and a second protective layer contacting the solid polymer electrolyte. Since only the second protective layer includes the water-repellent particles, in the protective layer, a large amount of the water-repellent particles exists at the solid polymer electrolyte membrane side than at the catalyst layer side. Thus, since the large amount of the water-repellent particles exists at the solid polymer electrolyte membrane side, the amount of fuel cross over passing the cracks in the catalyst layers can be drastically decreased without decreasing the three-phase interface in the catalyst layer, i.e., the active electrode surface.

In step (a), the cathode catalyst layer and the anode catalyst layer may be formed by a conventional method in the art. For example, the catalyst layer may be formed on a supporting material. The supporting material may be a diffusion layer.

The first paste used in step (b) can be prepared by mixing a polymer electrolyte and a predetermined dispersion medium, for example. The second paste may be prepared by mixing a polymer electrolyte, water-repellent particles, and a predetermined dispersion medium. For the polymer electrolyte and the water-repellent particles, those mentioned above may be used. For the dispersion medium, for example, the dispersion medium that can disperse both the polymer electrolyte and the water-repellent particles, for example, an aqueous solution including alcohol such as an aqueous isopropanol solution can be used. For the first paste, a polymer electrolyte may be dissolved in a predetermined solvent for the use.

The first paste and the second paste are preferably applied on the catalyst layer by spraying. By spraying, the paste including the polymer electrolyte and the water-repellent particles is allowed to enter into micro-cracks of the catalyst layer reliably as small droplets. Also, spraying is an effective method for forming a uniform, thin membrane. Thus, by using the spraying method, a uniform protective layer can be formed.

The surface temperature of the catalyst layer at the time of spraying the first paste and the surface temperature of the first protective layer at the time of spraying the second paste are preferably 40 to 80° C. For example, by setting the surface temperature of the catalyst layer within the above temperature range upon applying the first paste on the surface of the catalyst layer, the polymer electrolyte can be deposited while drying the small droplets including the polymer electrolyte on the applied surface. Upon applying the second paste on the surface of the first protective layer as well, the polymer electrolyte and the water-repellent particles can be deposited, while drying small droplets including the polymer electrolyte and the water-repellent particles on the surface of the first protective layer. Such way of application enables avoiding generation of micro-cracks on the protective layer itself. However, when the surface temperatures of the catalyst layer and the first protective layer exceed 80° C., since the evaporation speed of a volatile component in the paste (that is, the dispersion medium or the solvent mentioned above) becomes too fast, structure of the polymer electrolyte and structure of the water-repellent particles in the protective layer become non-uniform. When the surface temperature is below 40° C., since the evaporation speed of the volatile component in the paste becomes too slow, a large portion of the dispersion medium or the solvent evaporates from the inside of the protective layer even after its formation. Thus, micro-cracks are produced easily in the protective layer.

In step (c), the cathode catalyst layer, the solid polymer electrolyte, and the anode catalyst layer may be joined, for example, by hot pressing. In the present invention, since the cathode protective layer and the anode protective layer are provided between the solid polymer electrolyte membrane and the cathode catalyst layer, or between the solid polymer electrolyte membrane and the anode catalyst layer, the solid polymer electrolyte membrane and each catalyst layer can be joined with a low pressure. Thus, since the joining can be carried out with a low pressure, the porosity of the catalyst layer can be prevented from decreasing, while achieving a low interface resistance.

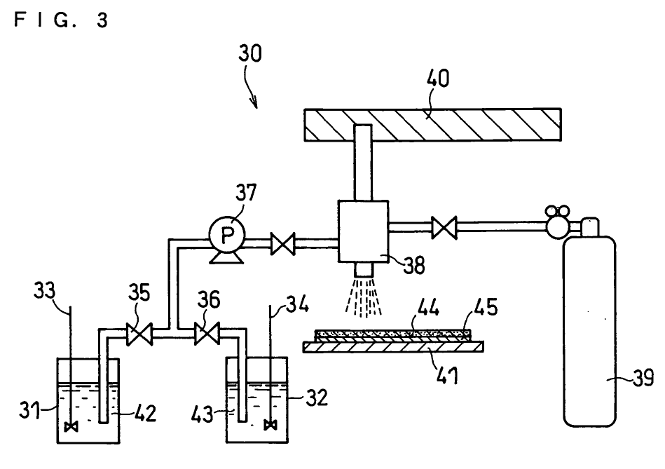

In step (b) mentioned above, the first paste and the second paste may be sprayed by using the spraying apparatus as shown in FIG. 3.

A spraying apparatus 30 in FIG. 3 comprises a first tank 31, a second tank 32, a first mixer 33, a second mixer 34, a first valve 35, a second valve 36, a pump 37, a spray nozzle 38, a cylinder 39, an actuator 40, and a heater 41.

Charged in the first tank 31 is a first paste 42, i.e., a polymer electrolyte dissolved or homogenously dispersed in a solvent or a dispersion medium. Charged in the second tank 32 is a second paste 43, i.e., a polymer electrolyte and water-repellent particles homogenously dispersed in a dispersion medium. The first paste 42 and the second paste 43 are constantly mixed by a first mixer 33 and a second mixer 34, respectively.

The paste supply to the spray nozzle 38 is changed from the first tank 31 to the second tank 32, or vise versa, by using a first valve 35 and a second valve 36. The selected paste is supplied to the spray nozzle 38 by the pump 37. To the spray nozzle 38, a jet gas is also supplied from the cylinder 39. For the jet gas, for example, nitrogen gas may be used.

The spray nozzle 38 can be moved by the actuator 40 at an arbitrary speed in 2 directions, to the direction of X-axis and of Y-axis. The spray nozzle 38 is disposed at above of the catalyst layer 44. For example, the spray nozzle 38 moves while ejecting the first paste 42 to spray the first paste 42 uniformly on the catalyst layer 44. The heater 41 dries the paste to form the first protective layer. The catalyst layer 44 is supported by a supporting material 45.

Afterwards, the first valve 35 and the second valve 36 are operated to supply the second paste 43 into the spray nozzle 38. The second paste 43 is sprayed on the first protective layer in the same manner as the above, and dried, to obtain a second protective layer.

The protective layer including the first protective layer and the second protective layer can be formed on the surface of the catalyst layer as shown in the above. The catalyst layer and the first protective layer are preferably heated by the heater 41, while the first paste and the second paste are being applied, as described in the above.

The above describes a method for manufacturing a protective layer including the first protective layer and the second protective layer. In the case when the protective layer comprises a single layer including a polymer electrolyte and water-repellent particles, in step (b) described above, the protective layer can be formed by applying the second paste on the catalyst layer and then drying. In this case as well, the second paste is preferably applied on the catalyst layer by spraying. The surface temperature of the catalyst layer for the second paste application is preferably in the above range.

The present invention is described in detail in the following based on Examples. However, these Examples are not to limit the present invention in any way.

### EXAMPLE 1

(Preparation of Anode Catalyst Layer)

Catalyst-carrying particles included in an anode catalyst layer were prepared by allowing carbon black, i.e., conductive carbon particles with an average primary particle size of 30 nm (Ketjen Black EC manufactured by Mitsubishi Chemical Corporation), to carry alloy particles including Pt and Ru (an average particle size of 30 Å). The ratio of Pt and of Ru relative to the total of carbon black, Pt, and Ru was set to 30 wt %.

Then, a dispersion in which the catalyst-carrying particles were dispersed in an aqueous isopropanol solution, and a dispersion in which a polymer electrolyte was dispersed in an aqueous isopropanol solution were mixed by a beads mill, to prepare a paste for an anode catalyst layer. In this paste, the weight ratio between the catalyst-carrying particles and the polymer electrolyte was set to 1:1. For the polymer electrolyte, perfluorocarbonsulfonic acid ionomer (Flemione manufactured by Asahi Glass Co., Ltd.) was used.

The paste for anode catalyst layer was applied on a polytetrafluoroethylene (PTFE) sheet (a Naflong PTFE sheet manufactured by NICHIAS Corporation) by using a doctor blade, and then dried for 6 hours at room temperature in the atmosphere, to prepare an anode catalyst layer.

(Preparation of Cathode Catalyst Layer)

Catalyst-carrying particles included in a cathode catalyst layer was prepared by allowing the same conductive carbon particles as in the above to carry Pt particles with an average particle size of 30 Å. The ratio of Pt particles relative to the total of carbon particles and Pt particles was set to 50 wt %.

The cathode catalyst layer was made on the PTFE sheet in the same manner as the anode catalyst layer except that these catalyst-carrying particles were used.

It was confirmed that the anode catalyst layer and the cathode catalyst layer had cracks.

(Formation of Protective Layer)

Then, a protective layer was formed on the anode catalyst layer and on the cathode catalyst layer to cover the cracks.

For the polymer electrolyte, perfluorocarbonsulfonic acid ionomer (Flemion® manufactured by Asahi Glass Co., Ltd.) was used, and for the water-repellent particles, polytetrafluoroethylene (PTFE) resin particles (an average particle size: about 1 μm) were used.

In this Example, a protective layer comprising a first protective layer including a polymer electrolyte but not including water-repellent particles, and a second protective layer comprising a polymer electrolyte and water-repellent particles was formed by using a spraying apparatus as shown in FIG. 3.

A first paste was prepared by dissolving the above polymer electrolyte in an aqueous isopropanol solution. In the first paste, the concentration of the polymer electrolyte was set to 3.0 wt %. The first paste was sprayed on each catalyst layer by using the spraying apparatus. Afterwards, the applied paste was dried for an hour at 60° C. in the atmosphere, to form the first protective layer.

Then, a second paste was prepared by dispersing the above polymer electrolyte and the water-repellent particles homogenously in an aqueous isopropanol solution. In the second paste, the mixing ratio between the polymer electrolyte and the water-repellent particles was set to 3:1 by weight. In the second paste, the concentration of the polymer electrolyte and the water-repellent particles in total was set to 3.9 wt %.

The second paste was applied on the surface of the first protective layer by using the spraying apparatus. Afterwards, the applied paste was dried for 3 hours at 60° C. in the atmosphere, to form a second protective layer. The protective layer including the first protective layer and the second protective layer was thus formed, from the catalyst layer side, on the anode catalyst layer and on the cathode catalyst layer. The thickness of the protective layer was set to 10 μm. At the time of spraying the paste, the surface temperature of the anode and cathode catalyst layers was 60° C.

(Fabrication of Fuel Cell)

The obtained anode and cathode catalyst layers were cut to give a size of 6 cm×6 cm, to obtain an anode catalyst layer sheet and a cathode catalyst layer sheet. Afterwards, each catalyst layer sheet was stacked with the solid polymer electrolyte membrane positioned therebetween, so that the face where the protective layer was formed contacted the solid polymer electrolyte membrane. The stack was joined by heat by hot pressing (135° C., 71 kg/cm², and 15 minutes), to obtain an assembly including the anode and cathode catalyst layers, and the solid polymer electrolyte membrane disposed therebetween. For the solid polymer electrolyte membrane, perfluoroalkylsulfonic acid ion-exchange membrane (Nafion® 117 manufactured by E.I. du Pont de Nemours and Company) was used. The amount of Pt and of Ru in the anode catalyst layer was 2.0 mg/cm², and the amount of Pt in the cathode catalyst layer was 2.0 mg/cm².

Then, the PTFE sheet was removed from the anode and cathode catalyst layers of the assembly.

A carbon paper (TGP-H120 manufactured by Toray Industries, Inc.) was cut to give a size of 6 mm×6 mm, to obtain anode and cathode diffusion layers.

The anode diffusion layer, the assembly, and the cathode diffusion layer were joined by hot pressing (135° C., 28 kg/cm², and 15 minutes).

The anode diffusion layer was disposed at the side of the anode catalyst layer opposite to the side facing the solid polymer electrolyte membrane. Likewise, the cathode diffusion layer was disposed at the side of the cathode catalyst layer opposite to the side facing the solid polymer electrolyte membrane. On the sides of the anode and cathode diffusion layers facing the catalyst layers, water-repellent carbon layers with a thickness of 30 μm were provided.

Further, gas sealing materials were thermally adhered around the anode and the cathode by hot pressing (135° C., 28 kg/cm², and 30 minutes). An electrolyte membrane-electrode assembly (MEA) 1 was thus produced.

Then, the obtained MEA 1 was sandwiched between a pair of separators, a pair of current collecting plates, a pair of heaters, a pair of insulating plates, and a pair of end plates, and the whole assembly was clamped by clamping rods. The clamping pressure at this time was set to 20 kgf per unit area (1 cm²) of the separator. The separator had a thickness of 4 mm and an outer dimension of 10 cm×10 cm. On the side of the separator contacting the diffusion layer, a serpentine type flow path with a width of 1.5 mm, and a depth of 1 mm was formed. For the current collecting plate and the end plate, a gold-plated stainless steel plate was used.

The fuel cell thus obtained was referred to as cell A.

### EXAMPLE 2

Cell B was fabricated in the same manner as Example 1, except that the surface temperatures of each catalyst layer and each first protective layer were set to 40° C. upon spraying the paste in the step of forming the anode and cathode protective layers.

### EXAMPLE 3

Cell C was fabricated in the same manner as Example 1, except that the surface temperatures of each catalyst layer and each first protective layer were set to 80° C. upon spraying the paste in the step of forming the anode and cathode protective layers.

### EXAMPLE 4

Cell D was fabricated in the same manner as Example 1, except that the surface temperatures of each catalyst layer and each first protective layer were set to 30° C. upon spraying the paste in the step of forming the anode and cathode protective layers.

### EXAMPLE 5

Cell E was fabricated in the same manner as Example 1, except that the surface temperatures of each catalyst layer and each first protective layer were set to 90° C. upon spraying the paste in the step of forming the anode and cathode protective layers.

### EXAMPLE 6

Cell F was fabricated in the same manner as Example 1, except that in the step of forming the protective layer, a protective layer with a thickness of 10 μm was formed on both anode and cathode catalyst layers by spraying only the second paste.

### EXAMPLE 7

In the step of forming the protective layer, the second paste was sprayed on both anode and cathode catalyst layers, first, and dried for an hour at 60° C. in the atmosphere, to form a second protective layer. Then, the first paste was sprayed on the second protective layer, dried for 3 hours at 60° C. in the atmosphere, to form the first protective layer. The protective layer including the second protective layer and the first protective layer was thus formed from the catalyst layer side on both anode and cathode catalyst layers. The thickness of the protective layer was set to 10 μm.

Cell G was fabricated in the same manner as Example 1, except for the above.

### COMPARATIVE EXAMPLE 1

Comparative cell 1 was fabricated in the same manner as Example 1, except that the protective layer was not formed on the anode and cathode catalyst layers.

### COMPARATIVE EXAMPLE 2

Comparative cell 2 was fabricated in the same manner as Example 1, except that the protective layer was not formed on the anode catalyst layer.

### COMPARATIVE EXAMPLE 3

Comparative cell 3 was fabricated in the same manner as Example 1, except that the protective layer was not formed on the cathode catalyst layer.

### COMPARATIVE EXAMPLE 4

In the step of forming the protective layer, only the first paste was sprayed on both anode and cathode catalyst layers, to form a protective layer with a thickness of 10 μm. Except for the above, comparative cell 4 was fabricated in the same manner as Example 1.

(Evaluation)

Cells A to F and comparative cells 1 to 4 were evaluated as in below.

(1) Methanol Cross Over Amount

A fuel, i.e., 4 mol/L of an aqueous methanol solution, was supplied to the anode at a flow rate of 0.4 cm³/min, and an oxidant, i.e., air, was supplied to the cathode at a flow rate of 1 L/min, so that each cell generates electricity at a cell temperature of 60° C., and a current density of 150 mA/cm². At this time, the amount of methanol (mol/min) discharged from the anode was determined. The amount of methanol consumed by electricity generation (5.597×10⁻⁴ mol/min), and the amount of methanol discharged from the anode as mentioned above were subtracted from the methanol supply amount (1.6×10⁻³ mol/min), and defined the result as the methanol cross over amount. The results obtained are shown in Table 1. In Table 1, the methanol cross over amounts are shown as the values converted to a current density unit (mA/cm²).

(2) Current-Voltage Characteristics

A fuel, i.e., 4 mol/L of an aqueous methanol solution, was supplied to the anode at a flow rate of 0.4 cm³/min, and an oxidant, i.e., air, was supplied to the cathode at a flow rate of 1 L/min, so that each cell generates electricity for 15 minutes at a cell temperature of 60° C., and a current density of 150 mA/cm². The voltage of each cell after 15 minutes of electricity generation was determined.

TABLE 1

| | Protective Layer | | | | | |
|---|---|---|---|---|---|---|
| | | | Distribution of | Temperature | Methanol | Voltage |
| | Anode | Cathode | Water-Repellent | of Applied | Cross Over | After |
| | Side | Side | Particles | Surface (° C.) | Amount (mA/cm²) | 15 min. (V) |
| Cell A | ◯ | ◯ | A | 60 | 34 | 0.436 |
| Cell B | ◯ | ◯ | A | 40 | 43 | 0.422 |
| Cell C | ◯ | ◯ | A | 80 | 39 | 0.428 |
| Cell D | ◯ | ◯ | A | 30 | 64 | 0.405 |
| Cell E | ◯ | ◯ | A | 90 | 51 | 0.414 |
| Cell F | ◯ | ◯ | C | 60 | 37 | 0.397 |
| Cell G | ◯ | ◯ | B | 60 | 41 | 0.376 |
| Comp. | X | X | — | — | 171 | 0.245 |
| Cell 1 | | | | | | |
| Comp. | X | ◯ | A | 60 | 146 | 0.298 |
| Cell 2 | | | | | | |
| Comp. | ◯ | X | A | 60 | 86 | 0.345 |
| Cell 3 | | | | | | |
| Comp. | ◯ | ◯ | — | 60 | 107 | 0.324 |
| Cell 4 | | | | | | |

◯: Present
X: Absent
A: Large amount at the solid polymer electrolyte side
B: Large amount at the catalyst layer side
C: Uniform distribution

As is clear from Table 1, the methanol cross over amount was decreased greatly in cells A to G, compared with the comparative cells. This is probably because the cracks possibly existed in the anode and cathode catalyst layers were covered by the protective layer and the methanol cross over via the cracks was suppressed.

Also, in cells A to G, the voltage after 15 minutes of electricity generation showed higher values compared with the comparative cells. This is probably because the interface bonding between the electrolyte membrane and the catalyst layer was secured even when the MEA fabrication was carried out by hot pressing under a low pressure.

Further, cells A to E, in which a larger amount of the water-repellent particles exist at the solid polymer electrolyte membrane side than at the catalyst layer side in the protective layer, showed comparatively higher voltage values. Thus, by making the amount of the water-repellent particles larger at the solid polymer electrolyte membrane side, the methanol cross over amount can be decreased greatly without decreasing the three-phase interface in the catalyst layer, i.e., the active electrode surface.

Especially, in the case of cells A to C, the voltage value was higher than the other cells. The reason is thought as follows. Upon fabricating these cells, the surface temperature of the surface to be sprayed was adjusted to be within an appropriate temperature range. Thus, while drying the small droplets including the polymer electrolyte, and the small droplets including the water-repellent particles and the polymer electrolyte on the applied surface, the polymer electrolyte, and the polymer electrolyte and the water-repellent particles were able to be deposited, which enabled avoidance of the micro-crack generation in the protective layer itself.

As described in the above, by providing the protective layer between the solid polymer electrolyte membrane and each catalyst layer, a direct oxidation fuel cell excellent in fuel utilization efficiency and electricity generation performance can be obtained.

As opposed to this, in comparative cells 1 to 3, voltage values after 15 minutes of electricity generation were low compared with cells A to E. In these comparative cells, the protective layer was not provided between the solid polymer electrolyte membrane and the catalyst layers, or, the protective layer was provided only between the anode catalyst layer and the solid polymer electrolyte membrane or between the cathode catalyst layer and the solid polymer electrolyte membrane. Thus, the methanol cross over amount increased greatly and current-voltage characteristics declined greatly.

In comparative cell 4, because the cathode and anode protective layers do not include the water-repellent particles, it becomes difficult to effectively suppress the penetration speed of methanol that penetrates and migrates in the protective layer. Thus, the methanol cross over amount increased and the current-voltage characteristics declined greatly.

A fuel cell of the present invention is excellent in fuel utilization efficiency and electricity generation performance. Thus, a fuel cell of the present invention is useful for a power source for, for example, mobile electronic devices such as mobile phones, personal data assistants (PDA), laptop computers, and camcorders. The fuel cell of the present invention can also be applied to a power source for electricity-powered scooters.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct oxidation fuel cell comprising a membrane-electrode assembly including a cathode, an anode, and a solid polymer electrolyte membrane disposed between said cathode and said anode:
wherein said cathode includes a cathode catalyst layer facing said solid polymer electrolyte membrane, and a cathode diffusion layer;
said anode includes an anode catalyst layer facing said solid polymer electrolyte membrane, and an anode diffusion layer;
both of said cathode catalyst layer and said anode catalyst layer have cracks;
a cathode protective layer is formed between said cathode catalyst layer and said solid polymer electrolyte membrane to cover the cracks of said cathode catalyst layer;
an anode protective layer is formed between said anode catalyst layer and said solid polymer electrolyte membrane to cover the cracks of said anode catalyst layer; and
both of said cathode protective layer and said anode protective layer include a polymer electrolyte and water-repellent particles.

2. The direct oxidation fuel cell in accordance with claim 1, wherein an amount of said water-repellent particles in said protective layer is larger at a solid polymer electrolyte membrane side than at a catalyst layer side.

3. The direct oxidation fuel cell in accordance with claim 2, wherein said protective layer includes a first protective layer contacting said catalyst layer and a second protective layer contacting the said solid polymer electrolyte membrane,
said first protective layer not including said water-repellent particles but including said polymer electrolyte, and
said second protective layer including said water-repellent particles and said polymer electrolyte.

4. The direct oxidation fuel cell in accordance with claim 1, wherein said water-repellent particles include a fluorocarbon resin.

5. The direct oxidation fuel cell in accordance with claim 1, wherein said polymer electrolyte comprises at least one ion-conductive functional group selected from the group consisting of a phosphonyl group, a phosphinyl group, a sulfonyl group, a sulfinyl group, a carboxyl group, a sulfo group, a mercapto group, an ether binding group, a hydroxyl group, a quaternary ammonium group, an amino group, and a phosphate group.

6. The direct oxidation fuel cell in accordance with claim 1, wherein a fuel supplied to said anode includes at least one organic compound selected from the group consisting of methanol and dimethyl ether.

7. A method of manufacturing a direct oxidation fuel cell, the method including the steps of:
(a) forming a cathode catalyst layer and an anode catalyst layer, both of said cathode catalyst layer and said anode catalyst layer having cracks;
(b) forming a cathode protective layer including a polymer electrolyte and water-repellent particles on said cathode catalyst layer, and an anode protective layer including a polymer electrolyte and water-repellent particles on said anode catalyst layer; and
(c) joining a solid polymer electrolyte membrane and said cathode catalyst layer with said cathode protective layer interposed therebetween, and said solid polymer electrolyte membrane and said anode catalyst layer with said anode protective layer interposed therebetween.

8. The method of manufacturing a direct oxidation fuel cell in accordance with claim 7, wherein said step (b) further includes the steps of:
applying a first paste not including water-repellent particles but including a polymer electrolyte on each catalyst layer to form a first protective layer so that said cracks are covered; and
applying a second paste including a polymer electrolyte and water-repellent particles on said first protective layer to form a second protective layer.

9. The method of manufacturing a direct oxidation fuel cell in accordance with claim 8,
wherein said step of forming said first protective layer includes spraying said first paste on said catalyst layer and drying said first paste; and
said step of forming said second protective layer includes spraying said second paste on said first protective layer and drying said second paste.

10. The method of manufacturing a direct oxidation fuel cell in accordance with claim 9, wherein a surface temperature of said catalyst layer at the time of spraying said first paste or a surface temperature of said first protective layer at the time of spraying said second paste is set to 40 to 80° C.
